(19) United States
(12) Patent Application Publication
(10) Pub. No.: US 2012/0226827 A1
(43) Pub. Date: Sep. 6, 2012

(54) Mechanism for Performing SDIO Aggregation and Conveying SDIO Device Status to the Host Software

(75) Inventors: Lalit Yerramilli Raju, Santee, CA (US); Dagbegnon Henri Bahini, San Diego, CA (US); Hok Y. Cheung, Milpitas, CA (US); Neelay Das, Sunnyvale, CA (US)

(73) Assignee: QUALCOMM Incorporated, San Diego, CA (US)

(21) Appl. No.: 13/039,132

(22) Filed: Mar. 2, 2011

(51) Int. Cl. G06F 3/00; G06F 13/28

(52) U.S. Cl. 710/5

(57) ABSTRACT

The subject matter disclosed herein relates to systems and/or devices capable of transmitting data packets over a hardware command interface. In one particular example, multiple data packets may be transmitted between a host device and a peripheral device in a single hardware interface command.

### 1. FIELD

Subject matter relates to hardware command interface capable of transmitting multiple data packets in a single hardware interface command and/or transaction.

### 2. INFORMATION

The Secure Digital (SD) Card Association defines functionality for Secure Digital Input/Output (SDIO) devices in the SDIO Simplified Specification Version 2.00, Feb. 8, 2007 (hereinafter “SDIO Simplified Specification”) allowing for the interchangeability of different memory options with electronic devices such as mobile communication devices. Such memory options may include, for example, the use of a memory stick and/or an SD card. Here, a so called “SDIO card” may comprise an advanced form of an SD card in which a central processing unit (CPU) and/or microcontroller may be incorporated to host one or more advanced applications on a device. As such, SDIO cards have been used to provide advanced functionality for Bluetooth® adapters, navigation receivers, television tuners, cameras, scanners, just to name a few examples. In a particular example, SDIO cards have been used to provide advanced functionality in Smartphone, enabling applications such as music, video, email, Internet browsing, using of a phone cellular connection and/or nearby wireless LAN hotspots.

### SUMMARY

In one aspect of an implementation, two or more data packets may be combined for transmission in a single hardware interface command. It should be understood, however, that this is merely an example implementation and claimed subject matter is not limited in this respect.

### BRIEF DESCRIPTION OF THE FIGURES

Non-limiting and non-exhaustive features will be described with reference to the following figures, wherein like reference numerals refer to like parts throughout the various figures:

FIG. 1 is a schematic diagram of a system capable of transmitting data packets across a hardware command interface;

FIG. 2A shows a format for transmission of multiple data packets across a hardware command interface in a single transaction responsive to a single hardware interface command according to an implementation; FIG. 2B shows a format for a transmit start descriptor which may be used for separating sequential data packets forwarded in a single transaction responsive to a hardware interface command according to an implementation;

FIGS. 2C, 2D and 2E show formats for a direct memory access (DMA) descriptor according to particular implementations;

FIG. 3A is a flow diagram illustrating a process for initiating transmission of multiple data packets in a single transaction responsive to a single hardware interface command;

FIG. 3B is a flow diagram of a process for obtaining multiple data packets from a single write command received at a hardware interface according to an implementation;

FIG. 4 is a flow diagram illustrating a process for obtaining multiple data packets in a single response message in response to an interrupt signal according to an implementation;

FIG. 5 shows a format for a message transmitted in response to a read command received at a hardware interface according to an implementation;

FIG. 6 shows a format for a start descriptor for use in a receive frame according to an implementation;

FIG. 7 shows a format for a receive frame end descriptor according to an implementation; and

FIG. 8 is a flow diagram of a process for initiating transmission of multiple data packets in response to a read command according to an implementation.

### DETAILED DESCRIPTION

Reference throughout this specification to “one example”, “one feature”, “an example” or “one feature” means that a particular feature, structure, or characteristic described in connection with the feature and/or example is included in at least one feature and/or example of claimed subject matter. Thus, the appearances of the phrase “in one example”, “an example”, “in one feature” or “a feature” in various places throughout this specification are not necessarily all referring to the same feature and/or example. Furthermore, the particular features, structures, or characteristics may be combined in one or more examples and/or features.

As discussed above, an SDIO card may be implemented in any one of several different types of consumer electronics devices, including, for example, devices capable of communicating over a wireless communication network. Such devices typically transmit and/or receive data packets according to any one of several different communication protocols such as an Internet protocol and/or any one of several protocols implementable on a wireless communication network.

In this context, a “data packet” may refer to a unit of information that is capable of being routed from a source to a destination in a network according to a particular communication protocol. In one example, a data packet may comprise a datagram defining a header portion and a payload. Here, such a header portion may specify a source address and a destination address. A payload portion may provide information of interest to be transmitted from a source to a destination. In particular examples, a data packet may have a variable length, and need not be a fixed length and/or payload capacity. In this context, a data packet may also comprise a control packet or control frame containing information not directly related to a communication application layer or addressed for transmission to a device. It should be understood, however, that these are merely particular examples of a data packet and that claimed subject matter is not limited in this respect. As data packets are received at a receiver, for example, sequential and/or ordered data packets may be stored in a buffer in the form of a first in first out (FIFO) queue. A host device hosting applications may then retrieve data packets stored in such a queue in support of one or more hosted applications. Similarly, a host device in such a device may form a buffer in a host device main memory for storing sequential and/or ordered packets for transmission to another device on a network. Here, packets may be sequentially transmitted from the host device main memory buffer (e.g., in the form of a FIFO buffer or linked data structure in flat memory) to a transmitter component for transmission over a medium such as a wireless air interface.

Data packets may be transmitted between a host device and a transmission and/or receiving circuitry over a specialized bus and/or hardware command interface. In this context, a “hardware command interface” relates to a combination of hardware and/or signaling logic that enables first device to issue “hardware interface commands” to a second device to carry out an action and/or transaction. In one particular implementation, such a first device may comprise a host processor, host device, host controller, master device and/or the like, just to name a few examples. Likewise, such a second device may comprise a peripheral device, peripheral controller, slave device and/or the like, just to name a few examples. In one particular example, a hardware command interface may specify a particular signaling bus for transmitting commands and/or data between such a first and second device. A hardware command interface may also define particular hardware interface commands according to a particular signaling format (e.g., on a signaling bus).

In a particular implementation, a host device may initiate hardware interface commands such as “write commands” and/or “read commands” to transmit or receive data packets. Here data packets received at a receiver, and stored at the receiver (e.g., in a FIFO buffer or linked data structure in a flat memory), may be retrieved by a host device by using read commands applied to the hardware command interface to initiate one or more “read transactions.” The host device may then process the received data packets in support of one or more hosted applications. Similarly, a host device may initiate write commands to forward or transmit data packets across a hardware command interface to transmission circuitry in a “write transaction” for transmission over a network.

In a particular implementation, read and/or write commands may specify addresses (e.g., associated with physical memory locations) to which data is to be read from or written to. It should be understood, however, that these are merely examples of aspects of a hardware command interface and associated hardware interface commands according to particular implementations, and that claimed subject matter is not limited in this respect.

As network data rates increase and as applications become more data intensive, utilization of bus circuitry for transmission of data packets between a host device and transmission circuitry increases, making bus resources scarce. Also, latencies associated with sequentially transmitting individual data packets across a bus between a host device and transceiver circuitry may disadvantageously affect the performance of certain real-time applications hosted on the host device.

In one particular implementation, two or more data packets for transmission in a wireless communication network may be combined into a single hardware interface command for transmission through a hardware command interface for transmission from a host device to a peripheral device. In another aspect, multiple data packets received at a receiver from a wireless communication network may be retrieved by a host device in a single read command provided to a hardware command interface. It should be understood, however, that these are merely example implementations, and that claimed subjected matter is not limited in this respect. Here, by combining multiple data packets for transmission in response to a single hardware interface command, bus utilization and latencies may be reduced.

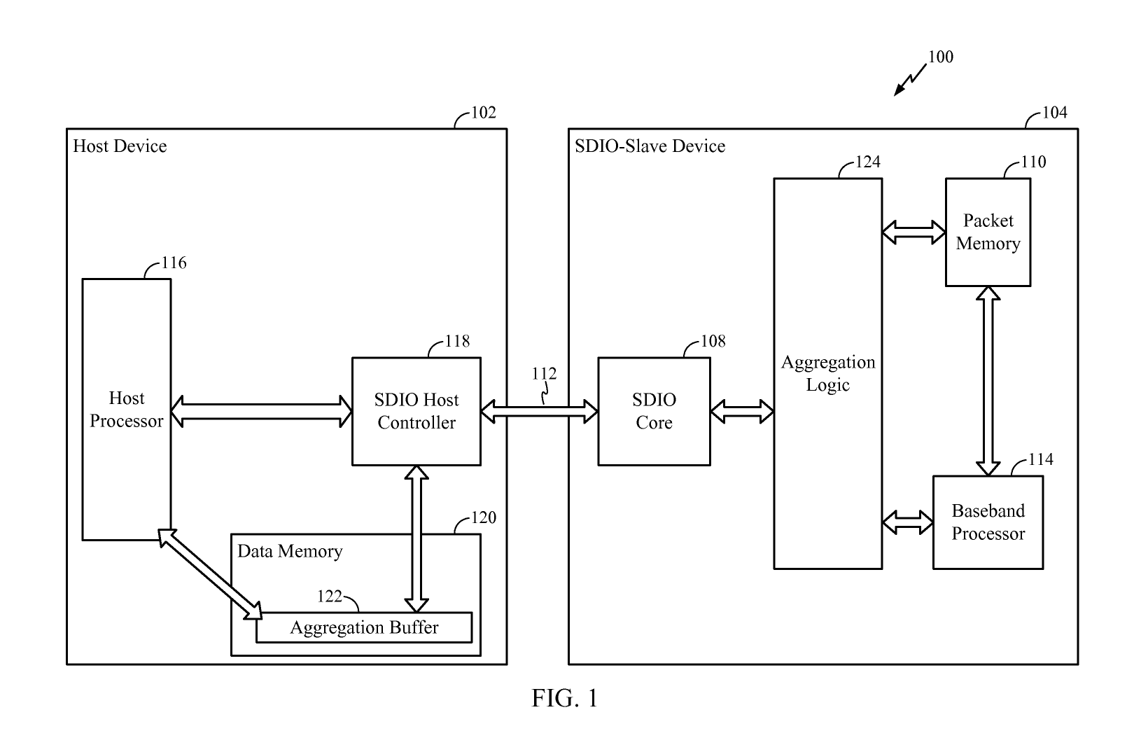

FIG. 1 is a schematic diagram of components that may be implemented in any of several different types of devices, including a wireless communication device capable of communicating with other devices on any one of several wireless communication networks. Such devices may include, for example, a Bluetooth® enabled device, a wireless LAN enabled device, a cellular network enabled device, just to name a few examples. As shown, a host device 102 communicates with a peripheral device 104 over a hardware command interface 112. In an example embodiment, host device 102 may comprise a broadband mobile station modem (MSM) while peripheral device 104 may comprise an IEEE std. 802.11 radio transceiver. However, this is merely an example embodiment and claimed subject matter is not limited in this respect. In the particular illustrated implementation, hardware command interface 112 coupled between an SDIO host controller 118 and SDIO core 108 may comprise a command signaling bus (e.g., in an SDIO hardware command interface as shown in section 2.0 of the SDIO Simplified Specification) for transmitting commands between host device 102 and peripheral device 104. Hardware command interface 112 may also include a data signaling bus (not shown) for transmitting data between host device 102 and peripheral device 104 in byte-wide quantities, for example. In one particular implementation, a command from host device 102 on a command signaling bus is followed by a response message from peripheral device 104 over the command signaling bus. Following the end of such a response message, data may be transferred between peripheral device 104 and host device 102 over a data signaling bus. It should be understood, however, that this is merely one example of a hardware command interface according to a particular implementation, and that claimed subject matter is not limited in this respect.

In a particular implementation, host device 102 may be capable of communicating with other devices as an SD host device. Similarly, peripheral device 104 may comprise a device that is responsive to SDIO compliant hardware commands. As such, in a particular implementation, such a hardware command interface used for communication between host device 102 and peripheral device 104 may comprise an SDIO compliant hardware command interface. It should be understood, however, that this is merely an example of a hardware command interface according to a particular implementation and that claimed subject matter is not limited in this respect.

In one particular implementation, peripheral device 104 is coupled to a transmitter and/or receiver (not shown) through baseband processor 114 to communicate with any one of several devices over a wireless communication network, using any one of several different types of wireless communication protocols. For example, peripheral device 104 using baseband processor 114 may be capable of performing baseband processing of data packets for transmission on a wireless communication network and/or performing baseband processing of received and downconverted signals for recovering received data packets.

In one example implementation, peripheral device 104 may form a FIFO queue in packet memory 110. Packet memory 110 may comprise any one of several types of volatile or non-volatile memory devices such as, for example, RAM, EEPROM, magnetic storage devices and phase change memory devices, just to name a few examples. Here, packet memory 110 may store sequential data packets in a FIFO buffer to be retrieved by host device 102 through read commands issued to the hardware command interface by host device 102. Alternatively, packet memory 110 may be configured as flat memory for storing data packets in a linked data structure, for example. Here, for example, multiple data packets may be forwarded between host device 102 and peripheral device 104 in flat memory in a single direct memory access (DMA) transaction. Host device 102 may then process the retrieved data packets in support of any one of several applications hosted thereon. Similarly, host device 102 may maintain an aggregation buffer 122 in data memory 120 for storing data packets to be transmitted to a network through peripheral device 104. Here, host device 102 in a particular implementation may include a host processor 116, such as a CPU, and data memory 120 for hosting any one of several applications. For example, and as discussed below, data memory 120 may comprise any one of several non-transitory storage mediums storing machine-readable instructions which are executable by host processor 116 to provide a desired result. Host device 102 may forward data packets stored in aggregation buffer 122 to peripheral device 104 by initiating write commands to hardware command interface 112.

In a particular implementation shown in FIG. 1, peripheral device 104 includes an SDIO core 108 which is capable of communicating with the host device 102 using SDIO commands. As such, SDIO core 108 may be capable of responding to SDIO read or write commands, such as read or write commands formatted as SDIO CMD53 commands according to section 5.3 of the SDIO Simplified Specification. For example, SDIO core 108 may respond to a read command from host device 102 by retrieving data packets from a FIFO buffer maintained in packet memory 110. Similarly, SDIO core 108 may respond to write commands from host device 102 for forwarding data packets for transmission through a wireless network as discussed above. It should be understood, however, that particular use of an SDIO core capable of responding to SDIO CMD53 commands is merely an example of logic that may be employed in facilitating communication between a peripheral device and a host device over a hardware command interface, and that claimed subject matter is not limited in this respect. As discussed below, SDIO core 108 may be implemented in any one of several combinations of circuitry and/or logic including, for example, in one or more application specific integrated circuits, digital signal processors, digital signal processing devices, programmable logic devices, field programmable gate arrays, processors, controllers, microprocessors, electronic devices or other device units designed to perform particular functions described herein.

In a particular implementation, applications hosted on host device 102 may communicate with hardware command interface 112 through a host driver comprising a layered software stack. Here, for example, such applications may communicate with a TCP/IP layer, which communicates with a network communication layer (e.g., according to a wireless communication protocol), which communicates with a hardware command interface layer (e.g., SDIO command interface layer). Such a hardware command interface layer may then communicate with hardware command interface 112 through a controller layer such as, for example, a FIFO engine and/or DMA engine.

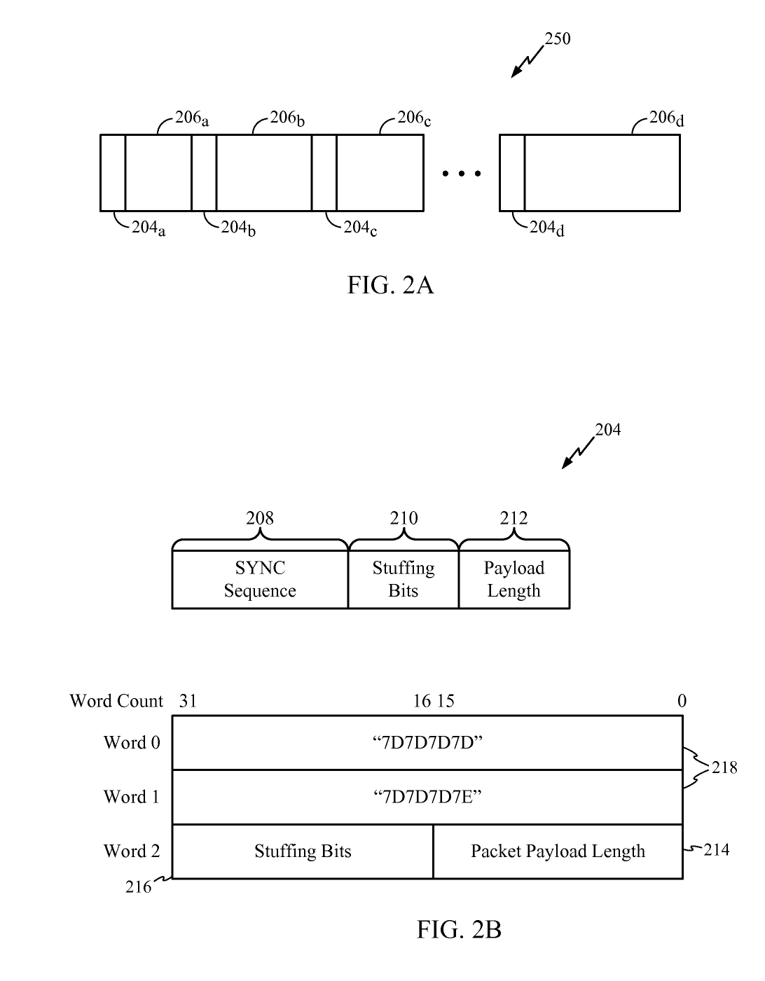

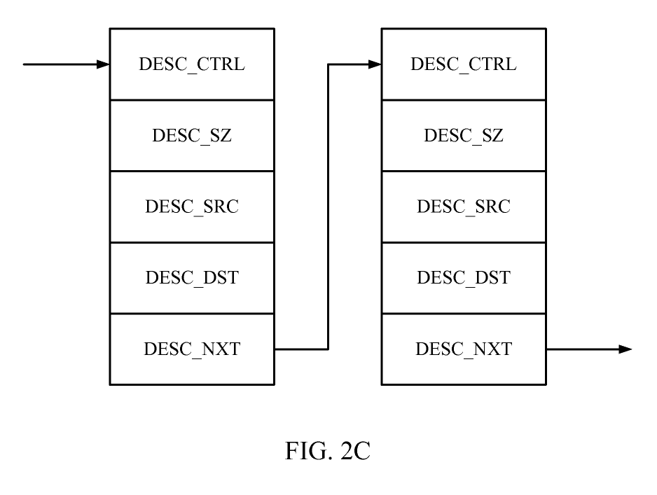

FIG. 2A shows a format for data being transmitted in response to a write command provided to hardware command interface 112 for forwarding multiple data packets in a single write transaction according to an implementation. In this particular implementation, data packets forwarded to peripheral device 104 over hardware command interface 112 may be formatted to be processed by a FIFO engine (not shown). In a particular implementation, transfer of data 250 may occur on a data signaling bus of hardware command interface 112 as initiated by host device 102 for initiating transmission of data packets to a wireless communication network in support of one or more applications, as discussed above. In one particular example, data 250 may be transferred in response to a modified CMD53 command. Here, a CMD53 write or read command may include signals on a command signaling bus according to an IO_RW_EXTENTED command format according to section 5.3 of the Simplified SDIO Specification. In a particular implementation, an IO_RW_EXTENTED command format may specify particular fields such as, for example, R/W flag to indicate whether the command is a read or write command, block mode bit to indicate whether the transaction is to be a byte mode or block mode and/or register address. In a particular implementation in which multiple data packets are transferred in a single read or write command as discussed above, the block mode bit may be set to block mode to accommodate large data sizes. The register address field may specify a specific address of a receive or transmit FIFO buffer in packet memory 110. Following transmission of such an IO_RW_EXTENTED command, data 250 may be transmitted on a data signaling bus where data packets 206 are separated by transmit start descriptors 204. In one particular example, data packets combined in a payload of a CMD53 write command may be combined in a particular sequential order. Here, aggregation logic 124 and/or SDIO core 108 may include a FIFO engine (not shown) that is capable of de-aggregating the multiple data packets from the single command and storing the data packets in a FIFO queue formed in packet memory 110 (e.g., for transmission on a network). As discussed above, by combining multiple data packets 206 in a single write command, bus utilization and latencies in transferring received data packets to host memory may be reduced.

FIG. 2B shows a format for a transmit start descriptor 204 which may be interleaved with data packets in a single write command as discussed above in connection with FIG. 2A. In this particular example, transmit start descriptor 204 comprises multiple fields including a synchronization sequence 208 followed by a stuffing bits 210, followed by a payload length 212 specifying a payload length. In a particular implementation, fields synchronization sequence 208, stuffing bits 210 and payload length 212 may have 64-bits, 16-bits and 16-bits, respectively. It should be understood, however, that these are merely examples of the size of such fields in a particular implementation, that the particular number of bits in such fields may be varied to suit the requirements of a particular application, and that claimed subject matter is not limited in this respect. With a payload length specified in start descriptors 204, for example, information decoded from start descriptors 204 may be used to parse individual data packets 206 (e.g., by aggregation logic 124) from data received from a data signaling bus of hardware command interface 112 transferred in response to a single write command.

In an alternative implementation, a single write command may be used to forward multiple data packets from host device 102 to peripheral device 104 in linked data structure to be processed by a DMA engine. In one implementation, data packets transferred in a write command may be preceded by an initial start descriptor that is decoded and processed at peripheral device 104 by a FIFO engine (not shown). Following the initial start descriptor may be a DMA transfer descriptor that is decoded and processed at a DMA engine (not shown) at peripheral device 104. Multiple data packets may then be separated by DMA transfer descriptors inserted before data packets in the data transferred in a write command over the hardware command interface.

FIGS. 2C through 2E show example formats of a DMA transfer descriptor according to an embodiment. As shown according to a particular implementation, such a DMA transfer descriptor may comprise the following six fields: DESC_CTRL; DESC_SZ; DESC_SRC; DESC_DST and DESC_NXT. In the particular illustrated examples of FIGS. 2D and 2E, fields DESC_SRC, DESC_DST and DESC_NXT provide alternative addressing schemes for a source address, destination address and pointer to an address of a subsequent DMA transfer descriptor, respectively. These fields may selectively provide an address to a location in a FIFO queue or location in a flat memory depending on information in locations PIQ, DIQ or SIQ of field DESC_CTRL. For example, if bit PIQ is set, an address pointer to a subsequent DMA transfer descriptor is to be a FIFO address located in bits 0 through 6 of field DESC_NXT. Otherwise if bit PIQ is cleared, an address pointer to a subsequent DMA transfer descriptor is to be a flat memory address located in bits 7 through 31 of field DESC_NXT. In a 32-bit addressing scheme according to a particular implementation, bits 7 through 31 may provided twenty-four least significant bits while the most significant eight bits are known and/or stored in a register, for example. A similar alternative addressing scheme may be implemented for fields DESC_SRC and DESC_DST by setting or clearing associated bits SIQ and DIQ.

Likewise, if bit SIQ is set, a source address identifying a location for obtaining the data to be transferred is to be a FIFO address located in bits 0 through 6 of field DESC_SRC. Otherwise if bit SIQ is cleared, a source address identifying a location for obtaining the data to be transferred is to be a flat memory address located in bits 7 through 31 of field DESC_SRC.

Similarly, if bit DIQ is set, a destination address identifying a location for storing transferred data is to be a FIFO address located in bits 0 through 6 of field DESC_DST. Otherwise if bit DIQ is cleared, a destination address identifying a location for storing transferred data address pointer to a subsequent DMA transfer descriptor is to be a flat memory address located in bits 7 through 31 of field DESC_DST.

In the particular embodiment illustrated above in which a single type of transmit start descriptor is provided for each data packet to be transferred in a single hardware interface, each transmit start descriptor may be required to be placed at the beginning of an SDIO data block. Since a FIFO engine may typically first look for content at the start or end of an SDIO data block, padding bytes (at times possibly approaching the size of an SDIO data block) may be inserted. Such padding may therefore reduce throughput because of unused transmission capacity. In a particular implementation, the DMA transfer descriptors discussed above may be aligned at DWORD (e.g., 32-bit) offsets. Here, interleaving DMA transfer descriptors between data packets following an initial transmit start descriptor (to be decoded by a FIFO engine) may obviate the need to include significant padding. As such, throughput may be improved over implementations using a FIFO transmit start descriptor preceding each data packet for transfer in a single hardware interface command.

Also, the alternate addressing scheme enabled by the use of DMA transfer descriptors shown in FIGS. 2D and 2E allow flexibility in transferring data packets between a FIFO data packet queue and a linked data structure in flat memory. For example, by having bit SIQ set to “1” and DIQ set to “0”, a DMA transfer descriptor may specify obtaining a data packet from a location of a source FIFO queue specified by bits 0 through 6 of a field DESC_SRC and storing the obtained data packet in a location of a flat memory specified by bits 7 through 31 of a field DESC_DST. Likewise, by having bit SIQ set to “0” and DIQ set to “1”, a DMA transfer descriptor may specify obtaining a data packet from a location of a flat memory specified by bits 8 through 31 of a field DESC_SRC and storing the obtained data packet in a location of a flat memory specified by bits 0 through 7 of a field DESC_DST.

In the particular alternative implementation of FIG. 2E, fields Src add Hi, Destn Add Hi and Nxt Pntr Add Hi provide additional flexibility to accommodate longer descriptors for use in particular implementations such as, for example, PCI/PCIE interfaces. Here, these fields may be valid if PIQ is set to “0.”

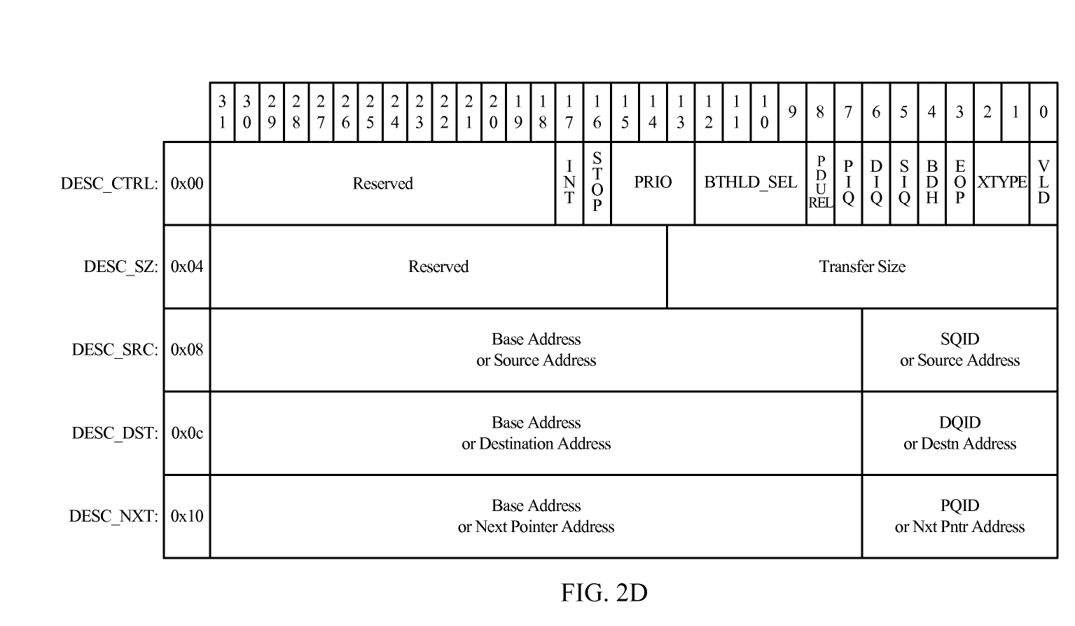

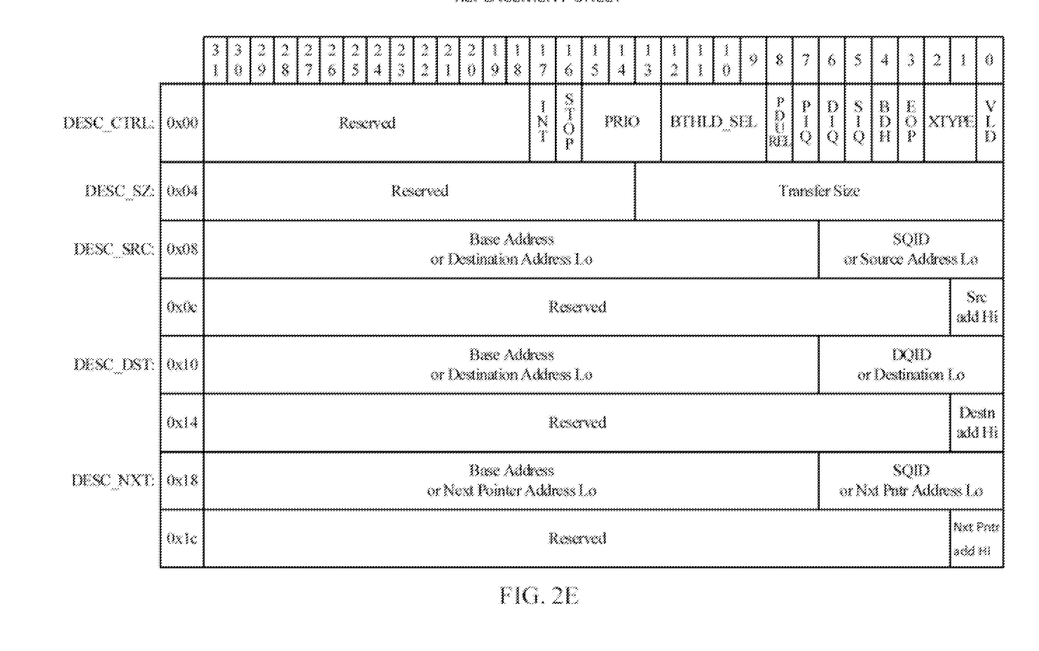

FIG. 3A is a flow diagram illustrating a process 300 for combining two or more data packets for transmission in a wireless network, such as combining multiple data packets in a single write command as shown in FIG. 2A. In one particular implementation, the process shown in FIG. 3A may be executed by a software driver hosted on host device 102 for forwarding data packets from main memory of host device 102 to peripheral device 104 for transmission in a wireless network as discussed above, for example. At block 302, two or more data packets are combined for transmission in a wireless network. This can be done, as discussed above in connection with FIG. 2A for example, such that multiple data packets are combined in sequential order in a single write command. At block 304 descriptors are inserted and interleaved between consecutive combined data packets transmitted in a data signaling interface of hardware command interface 112 as part of a single write command. As pointed out above in alternative embodiments, such inserted and interleaved descriptors may comprise transmit start descriptors to be decoded by a FIFO engine or DMA transfer descriptors to be decoded by a DMA engine. At block 306 a single write command to transmit a combination of the aforementioned packets may be initiated on a hardware command interface as discussed above, according to an SDIO CMD53 command format, for example. It should be understood, however, this is merely one example of how multiple data packets may be combined for transmission in a single write command on a hardware command interface, and that claimed subject matter is not limited in this respect.

In a particular implementation of the process of FIG. 3A, a single hardware interface command at block 306 may comprise a write command such as a write command according to an SDIO CMD53 format. Here, FIG. 3B is directed to a process for extracting multiple data packets from a single write command according to an implementation. In a particular implementation, such a process may be performed, at least in part, by SDIO core 108 of peripheral device 104. Here, for example, such a write command may comprise multiple data packets separated by interleaved transmit start descriptors such as transmit start descriptors shown in FIG. 2B, for example. A write command may be received at a hardware command interface at 350. By decoding interleaved transmit start descriptors separating data packets in the single received write command, aggregation logic 124 may parse extract the data packets at block 352 for transmission over a network. For example, aggregation logic 124 may determine the length of a data packet that follows a first start descriptor from payload length (e.g., payload length 214) and determine the location of a second start descriptor for a subsequent data packet based upon the payload length from the first start descriptor. Aggregation logic 124 may continue this process until all data packets are extracted from a write command. As discussed above, applications hosted on host device may communicate with a hardware command interface through a layered software communication stack including, for example, a TCP/IP layer, followed by a network communication layer (e.g., according to a particular wireless communication protocol), followed by a hardware command interface layer (e.g., SDIO), which is then followed by a hardware controller engine (e.g., FIFO engine and/or DMA engine). Here, aggregation of multiple data packets for transmission in a single hardware interface command (e.g., a single SDIO CMD 53 write command) may occur at a boundary between such a network communication layer and such a hardware command interface layer. Hence, a FIFO engine or DMA engine need not be modified to aggregate multiple data packets for transmission across a hardware command interface as part of a single read or write transaction.

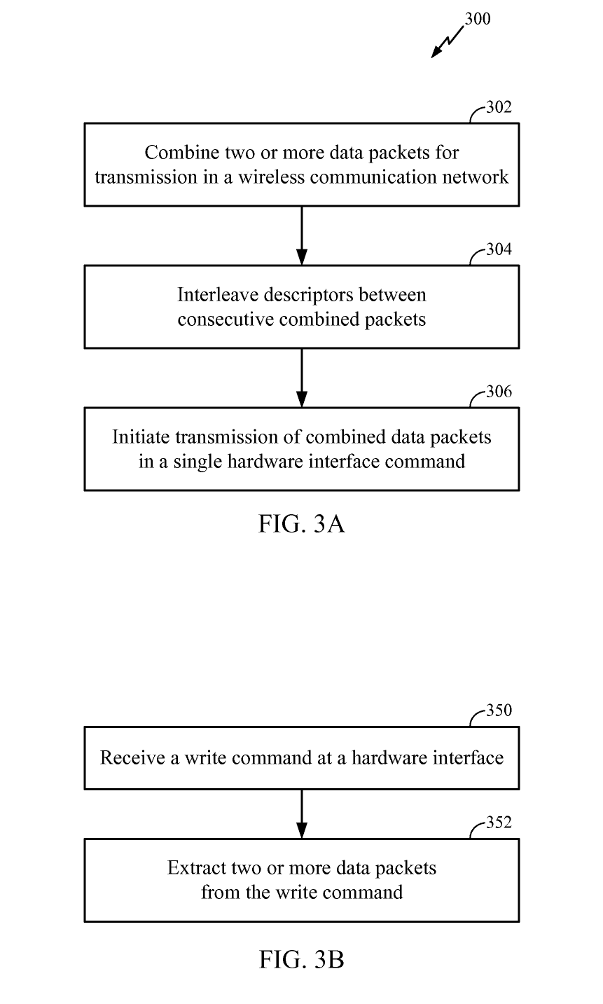

Embodiments discussed above in connection with FIGS. 2A through 3B are directed to transmission of multiple data packets in a single hardware interface command, such as for transmission through a wireless communication network. The process illustrated by FIG. 4 is directed to forwarding of multiple data packets in a single read transaction from a buffer to host memory, such as data memory 120 for host device 102. As discussed below, host device 102 may receive a hardware interrupt signal from device 104, such as from SDIO core 108, that is to be serviced by host device 102. For example, host device 102 may host one or more interrupt service routines which may be executed in response to an interrupt signal associated with particular hardware and/or interrupt events. As such, the process of FIG. 4 may be executed by such a driver hosted on host device 102 for the purpose of obtaining multiple data packets in a single hardware interface command, such as a CMD53 read command according the SDIO specification.

In one particular implementation, an interrupt service routine hosted on host device 102 may respond to an interrupt signal by initiating a CMD53 read command addressed to an interrupt status register (not shown) on SDIO core 108 indicating a type of interrupt that is to be serviced. If the type of interrupt indicates that received data is available to be read, host device 102 may initiate a subsequent CMD53 read command addressed to a receive buffer (e.g., on packet memory 110) to obtain received data for use by one or more applications.

In an alternative implementation, as discussed with reference to process 600 shown in FIG. 4, an interrupt service routine may respond to an interrupt signal from peripheral device 104 by, instead of initiating an initial read command to an interrupt status register, initiating a single CMD53 read command to a received data buffer. As discussed below in a particular implementation, an interrupt status indication may be combined with any data transferred in response to the single CMD53 read command (e.g., at aggregation logic 124), obviating any need for two separate CMD53 read commands.

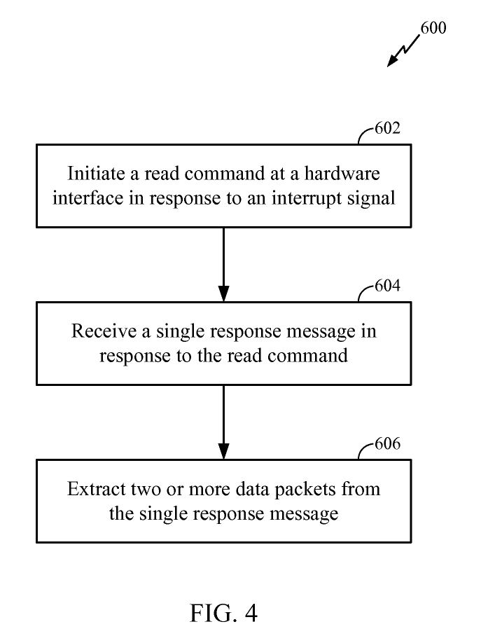

At block 602, a read command may be initiated at a hardware interface responsive to an interrupt signal. Such a read command may comprise a CMD53 read command as discussed above. In response to the read command, multiple data packets may be retrieved and transferred to host device 102 over data signaling bus of hardware command interface 112 as discussed above. Such multiple data packets may be obtained from a receive buffer maintained in a sequential FIFO buffer as discussed above. Alternatively, using DMA transfer descriptors as discussed above, such multiple data packets may be obtained from a linked data structure stored in a flat memory. At block 606, two or more data packets may be extracted from a single response message as discussed above for processing by one or more applications hosted on host device 102, for example. Here, as discussed below in greater detail, multiple data packets transferred in a single transfer of data in response to a single CMD53 read command may be combined in sequential fashion and separated by interleaved descriptors as shown in FIG. 5 (e.g., at aggregation logic 124) according to a particular example.

Sequential data packets 554 may be combined and separated by a receive start descriptor 552 and a receive end descriptor 556. Here, in this particular implementation, each data packet 554 is preceded by an associated start descriptor 552 and followed by an associated end descriptor 556. In a particular implementation, a host driver receiving response message 550 may be able to parse received data packets in single payload of a response message by identifying particular fields in start descriptors 552 and end descriptors 556 (e.g., at a boundary between network communication and hardware command interface layers of a layered software driver stack as discussed above).

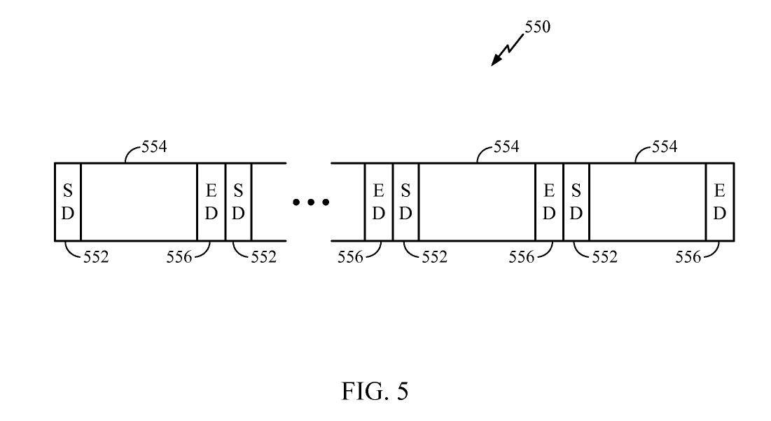

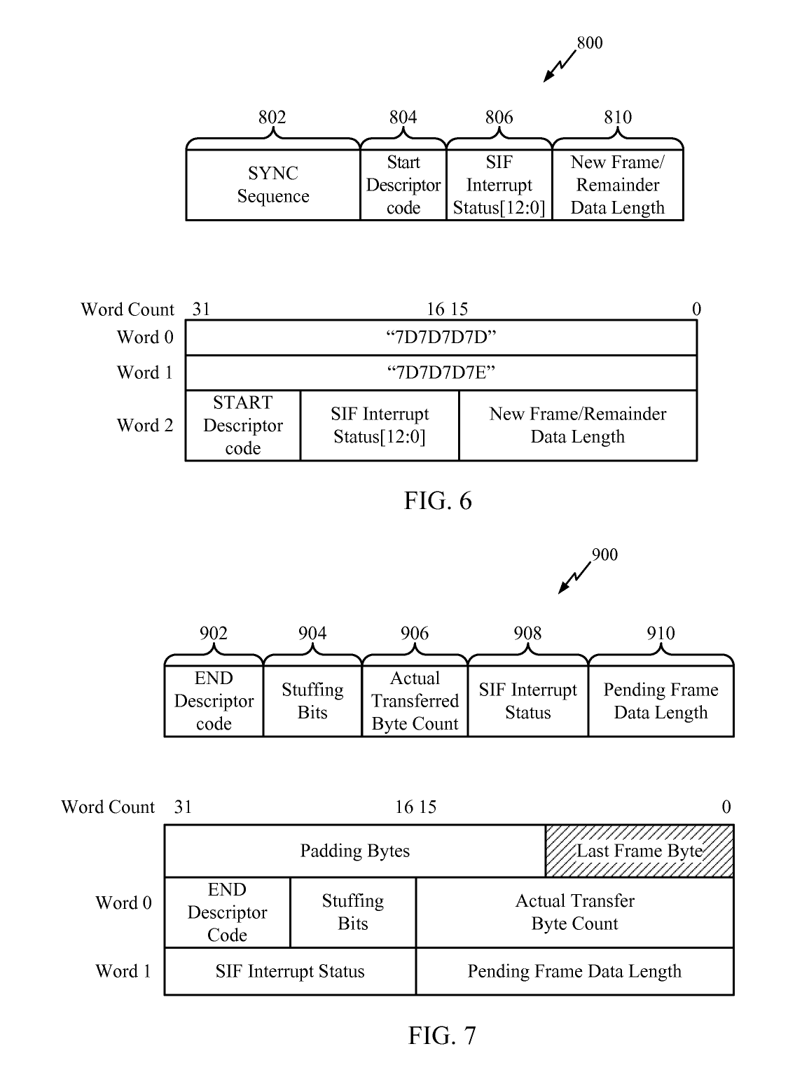

FIGS. 6 and 7 show particular examples of formats for a receive frame start descriptor, such as a start descriptor 552 as discussed above, and a receive frame end descriptor, such as an end descriptor 556 discussed above in FIG. 5. Here, it is shown that a receive frame start descriptor begins with a synchronization sequence 802, followed by a start descriptor code 804. Information in these fields may allow the host driver to determine that a data packet is to follow in a payload of a response message. Similarly, an end descriptor 900 as shown in FIG. 7 begins with an end descriptor code 902 followed by stuffing bits 904 and an actual transferred byte count 906.

In particular implementations, a receive frame start descriptor, such as receive frame start descriptor 800, and/or receive frame end descriptor, such as receive frame end descriptor 900, include a separate field indicating interrupt status such as the SIF interrupt status fields 806 and 908 shown in FIGS. 6 and 7. Here, these interrupt status fields may indicate one or more different types of events to be serviced by an interrupt service routine at host device 102, for example. Such interrupt events to service may include, for example, receipt of data packets in a FIFO buffer available to be read, hardware interrupts, error interrupts, power management related interrupts, just to name a few examples. As such, different interrupt service routines may be executed depending upon particular events specified in an interrupt status field 806 and/or 908. Also, such an interrupt status indicated in interrupt status fields 806 and/or 908 may eliminate a need for a driver (e.g., on host device 102) for issuing a subsequent read command (e.g., CMD52 read command according to sections 5.1 and 5.2 of the Simplified SDIO Specification) for obtaining interrupt status independently of a read command for obtaining data packets from a buffer. Here, a host may obtain interrupt status and any waiting data packets from a single read command responsive to an interrupt signal, instead of obtaining interrupt status in a register from a first read command followed by obtaining waiting data packets from a second read command.

In one particular implementation, data transferred across a data signaling bus of hardware command interface 112 in response to a read command, such as at block 604 as discussed above, may include all data packets remaining in a FIFO buffer queue (e.g., a FIFO queue maintained in packet memory 110) to be received and processed by applications hosted on host device 102. In another implementation, such a data transfer may not include all such data packets remaining in such a FIFO queue. Here, receive frame end descriptor 900 comprises a pending frame length field 910 to indicate the presence, quantity and/or location of any remaining data packets to be read/retrieved (e.g., from a FIFO buffer in packet memory 110 of peripheral device 104). As such, an additional read command (e.g., CMD53 read) may be issued for retrieval of such remaining data packets without waiting for an additional hardware interrupt signal indicating the presence of data packets are available to be read from a FIFO buffer.

In one particular implementation, a start descriptor code 804 in start descriptor 800 may indicate a type of data in an associated transport packet payload. For example, such a start descriptor code 804 may specify whether such a transport packet includes padding, a partial receive frame packet, a complete receive frame packet or a packet containing a remaining portion of a previously transmitted partial data packet.

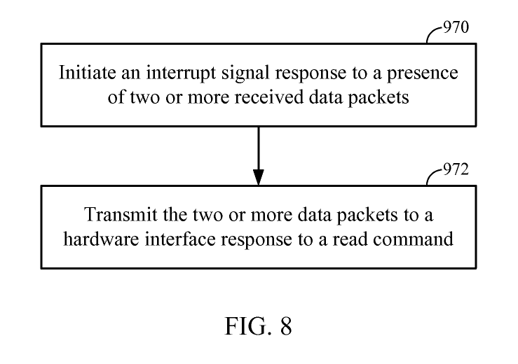

As discussed above in connection with FIG. 4, host device 102 may respond to an interrupt signal by initiating a read command to extract multiple data packets from a response message. FIG. 8 is a flow diagram of a process for initiating transmission of multiple data packets in such a response message according to an embodiment. At block 970, peripheral device 104 may initiate transmission of an interrupt signal in response to determining a presence of two or more received data packets. Such data packets may have been received, for example, from a wireless communication network and stored in packet memory 110.

On receiving a read command from host device 102 (initiated in response to an interrupt signal initiated at block 970), at block 972 peripheral device 104 may transmit the received data packets to a hardware interface in response to the read command. In a particular implementation, aggregation logic 124 may combine the multiple data packets in a single response message separated by start descriptors such as a start descriptor 800 shown in FIG. 6. Any interrupt condition may be also indicated in field 806, for example. As discussed above in connection with FIG. 4, host device 102 may then parse and extract the multiple data packets from the single response message by, for example, decoding the interleaved start descriptors. Here, for example, by decoding a start descriptor code 804, host device 102 can determine that a data packet is to follow a location beginning at a known location in the response message and ending according to data length field 810. This may continue until an end descriptor code 902 is detected, indicating that no further data packets are to follow.

As pointed out above, device 100 may, for example, be enabled (e.g., via one or more network interfaces) for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying” and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

In certain implementations, a specific apparatus may comprise one or more processors capable of executing machine-readable instructions from a storage medium. Here, such a storage medium may be provided as part of a physical article comprising any one of several memory devices such as, for example, semiconductor memory devices, optical memory devices, magnetic memory devices, phase change memory devices, just to name a few examples. Accordingly, in this context, a storage medium comprises a tangible thing capable of storing instructions, data, information, etc. As such, a storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state. The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

1. A method comprising:
combining two or more data packets for transmission in a wireless communication network, said two or more data packets remaining intact at least partially in response to said combining; and
initiating transmission of said combined data packets in a single hardware interface command.

2. The method of claim 1, wherein said single hardware interface command comprises an SDIO CMD53 write command.

3. The method of claim 1, wherein said combining said two or more packets comprises interleaving descriptors between consecutive ones of said two or more data packets.

4. The method of claim 3, wherein said interleaved descriptors comprise direct memory access transfer descriptors.

5. The method of claim 3, wherein said interleaved descriptors comprise transmit start descriptors.

6. The method of claim 1, wherein said data packets are not fixed length.

7. The method of claim 1, and further comprising retrieving said two or more data packets from a FIFO queue.

8. An article comprising:
a storage medium comprising machine-readable instructions which are executable by a processor to:
combine two or more data packets for transmission in wireless communication network, said two or more data packets remaining intact at least partially in response to said combining; and
initiate transmission of said combined data packets in a single hardware interface command.

9. An apparatus comprising;
means for combining two or more data packets for transmission in a wireless communication network, said two or more data packets remaining intact at least partially in response to said combining; and
means for initiating transmission of said combined data packets in a single hardware interface command.

10. The apparatus of claim 9, wherein said single hardware interface command comprises an SDJO: CMD53 write command.

11. The apparatus of claim 10, wherein said means for combining said two or more packets comprises means for interleaving descriptors between consecutive ones of said two or more data packets.

12. The apparatus of claim 9, wherein said means for combining said two or more packets comprises means for interleaving descriptors between consecutive ones of said two or more data packets.

13. The apparatus of claim 12, wherein said interleaved descriptors comprise direct memory access transfer descriptors.

14. The apparatus of claim 12, wherein said interleaved descriptors comprise transmit start descriptors.

15. A host device: comprising:
circuitry to transmit commands to a hardware command interface; and at least one processor to:
combine two or more data packets for transmission in a wireless communication network, said two or more data packets remaining intact at least partially in response to said combining; and
initiate transmission of said combined data packets in a single command through said hardware command interface.

16. The host device of claim 15, wherein said single hardware interface cornman4 comprises an SDIO CMD53 write command.

17. The host device of claim 16, wherein said at least one processor to combine said two or more packets by interleaving descriptors between consecutive ones of said two or more data packets.

18. The host device of claim 15, wherein said at least one processor to combine said two or more packets by interleaving descriptors between consecutive ones of said two or more data packets.

19. The host device of claim: 18, wherein said interleaved descriptors comprise direct memory access transfer descriptors.

20. The apparatus of claim 18 wherein said interleaved descriptors comprise transmit start descriptors.

21. A method comprising:
receiving a single command from a host device at a hardware command interface; and
extracting two or more intact data packets from said single command for transmission in a wireless communication network.

22. The method of claim 21, wherein said extracting further comprises detecting descriptors between consecutive ones of said two or more data packets in said single command.

23. The method of claim 22, wherein said descriptors comprise at least one transmit start descriptor.

24. The method of claim 22, wherein said descriptors comprise at least one DMA transfer descriptor indicative of a linked data structure, said DMA transfer descriptor identifying a location of at least one of said data packets.

25. The method of claim 22, wherein extracting said two or more data packets from said single command further comprises:
decoding information from said detected descriptors; and
parsing said two or more data packets from said single command based, at least in part, on said decoded information.

26. The method of claim 21, wherein said single command comprises an SDIO CMD53 write command.

27. An apparatus comprising:
means for receiving a single command from a host device at a hardware command interface; and
means for extracting two or more intact data packets from said single command for transmission. in a wireless communication network.

28. The apparatus of claim 27, wherein said means for extracting further comprises means for detecting descriptors between consecutive ones of said two or more data packets in said single command.

29. The apparatus of claim 28, wherein means for extracting said two or more data packets from said single command further comprises:
means for decoding information from said start descriptors; and
means for parsing said two or more data packets from said single command based, at least in part, on said decoded information

30. A peripheral device comprising:
circuitry to receive a hardware interface command from a host device; and
circuitry to extract two or more intact data packets from said single command for transmission in a wireless communication network.

31. A method comprising:
initiating a read command at a hardware command interface in response to an interrupt signal;
receiving a single response message in response to said read command; and
extracting two or more intact data packets from said single response message, said two or more data packets having been received from a wireless communication network.

32. The method of claim 31, wherein said extracting further comprises detecting descriptors in said single response message separating consecutive ones of said two or more data packets in said single response message.

33. The method of claim 31, and further comprising determining at least one interrupt event to be serviced associated with said interrupt signal based, at least in part, on information in a predefined field of said response message.

34. The method of claim 31, wherein said read command comprises an SDIO CMD53 read command.

35. The method of claim 31, and further comprising retrieving said two or more data packets from a FIFO queue.

36. The method of claim 31, and further comprising determining an amount of received data remaining in said F]FO queue based, at least in part, on one or more predetermined fields in said response message.

37. An article comprising:
a storage medium comprising machine-readable instructions stored thereon which are executable by a processor to:
initiate a read command at a hardware command interface in response to an interrupt signal; and
extract two or more intact data packets from a single response message received in response to said read command.

38. An apparatus comprising:
means for initiating a read command at a hardware command interface in response to an interrupt signal;
means for receiving a single response message in response to said read command; and
means for extracting two or more intact data packets from said single response message, said two or more data packets having been received from a wireless communication network.

39. A host device comprising:
circuitry to transmit commands to hardware command interface; and at least one processor to:
initiate transmission of a read command at said hardware command interface in response to an interrupt signal; and
extract two or more intact data packets from a single response message received in response to said read command.

40. A method comprising
initiating an interrupt signal in response to at least one event;
receiving a read command from a host device at a hardware command interface in response to said interrupt signal;
combining two or more data packets received from a wireless communication network, said two or more data packets remaining intact at least partially in response to said combining; and
transmitting a single response message responsive to said read command, said single response message comprising said two or more combined data packets.

41. The method of claim 40, wherein said read command comprises an SDIO CMD53 read command.

42. The method of claim 40, and further comprising retrieving said two or more data packets from a FIPO buffer.

43. The method of claim 42, and further comprising interleaving descriptors between consecutive ones of said two or more data packets in said response message.

44. The method of claim 40, wherein said single response message further comprises at least one field specifying a status of at least one interrupt.

45. The method of claim 44, wherein said status of said at least one interrupt indicates at least one type of interrupt event to be serviced.

46. An apparatus comprising:
means for initiating an interrupt signal in response to at least one event;
means for receiving a read command from a host device at a hardware command interface in response to said interrupt signal;
means for combining two or more data packets received from a wireless communication network, said two or more data packets remaining intact at least partially in response to said combining; and
means for transmitting a single response message responsive to said read command, said single response message comprising said combined two or more data packets.

47. A peripheral device comprising:
circuitry to initiate an interrupt signal in response to detection of at least one event; and
circuitry to initiate transmission of a single response message responsive to a read command received at a hardware command interface, said read command being transmitted by a host device in response to said interrupt signal, said single response message comprising a combination of two or more data packets received from a wireless communication network, wherein said two or more data packets remain intact at least partially in response to said combining.
